(19) United States
(12) Patent Application Publication
(10) Pub. No.: US 2005/0276544 A1
(43) Pub. Date: Dec. 15, 2005

(54) Optical digital audio system

(76) Inventor: Tsung - Ming Cheng, Taipei (TW)

Correspondence Address: TSUNG - MING CHENG;c/o : PATRICK POON, 525 E. LEMON AVENUE, ARCADIA, CA, 91006, US

(21) Appl. No.: 10/867,090

(22) Filed: Jun. 14, 2004

(51) Int. Cl. G02B 6/36

(52) U.S. Cl. 385/88

(57) ABSTRACT

An optical digital audio system has an input receiver module that connects with one or multiple output speaker module(s) via optical fiber cable(s). The input receiver module has an audio signal receiving device, an amplifier and control device, one or multiple digital-to-optical converter(s), and one or multiple optical signal transmitter(s). The output speaker module has an optical signal receiver, an optical-to-digital converter, a digital signal amplifier, a digital-to-analog converter, and a speaker.

### CROSS-REFERENCE TO RELATED APPLICATIONS

Not Applicable

### STATEMENT REGARDING FEDERALLY SPONSORED R & D

Not Applicable

### REFERENCE TO SEQUENCE LISTING, A TABLE, OR A COMPUTER PRGRAM LISTING COMPACT DISK APPENDIX

Not Applicable

### BACKGROUND OF THE INVENTION

This invention relates to digital audio system, especially to transmission and playback of digital audio signal with wired devices. This invention also relates to optical transmission and reception devices and optical fiber cable for use in the optical digital audio system.

Conventional audio system amplifies audio signal, then transmits the audio signal in analog format to speakers for sound output. The audio signal is carried by electric current through metal wire to the speakers to produce sound. Due to the electro resistance attribute of metal, the audio signal weakens and endures different levels of frequency loss while it travels through the wire. The result is an inferior audio output.

One conventional way to work around these problems is to further amplifying the audio signal, providing extra headroom to compensate for the signal loss and distortion during transmission. Also, thicker speaker wire is used at times to try to provide a better signal transmission, especially for speakers placed in more distant location. However, these methods still do not actually resolve the problem of signal loss and distortion; and these methods have characteristics of power inefficiency and inconvenience of bulky cable handling.

Nowadays almost all audio, video and multimedia equipments are moving toward digitalization. While these equipments are designed for sight and sound to be recorded, processed, manipulated, reproduced, and played back in digital format, digitalization on the audio side stops short at the stage of signal processing and amplification. Even when a digital input source is connected to feed audio signal in digital format to an amplifier, after the input signal is processed and amplified digitally, it is converted to analog format for transmission via metal wire to speakers for sound output. Therefore problems and deficiencies such as signal loss and distortion described above still exist.

### BRIEF SUMMARY OF THE INVENTION

In accordance with the present invention an optical digital audio system comprises an input receiver module and one or multiple output speaker module(s). The input receiver module connects with output speaker module or modules via optical fiber cable(s).

The optical digital audio system converts audio signal into optical format at the input receiver module, then transmits the signal to output speaker module or modules via optical fibers. At the output speaker module or modules, the optical signal is reverted to digital signal, then the signal is amplified, converted to analog format and combined with electrical power to activate speaker for sound reproduction.

The optical digital audio system transmits audio signal in optical format via optical fibers to retain the original audio quality, providing an end-to-end digital audio solution, thereby eliminates problems of signal loss and distortion of conventional analog speaker system.

### BRIEF DESCRIPTION OF THE SEVERAL VIEWS OF THE DRAWING

FIG. 1 shows a typical embodiment of this invention.

### REFERENCE NUMERALS IN DRAWINGS

10 audio signal receiving device
11 digital audio amplifier and control device
12 optical fiber cable
13 speaker
14 analog-power speaker driver
15 digital-to-optical converter
16 optical signal transmitter
17 optical signal receiver
18 optical-to-digital converter
19 digital signal amplifier
20 digital-to-analog converter

### DESCRIPTION OF THE INVENTION

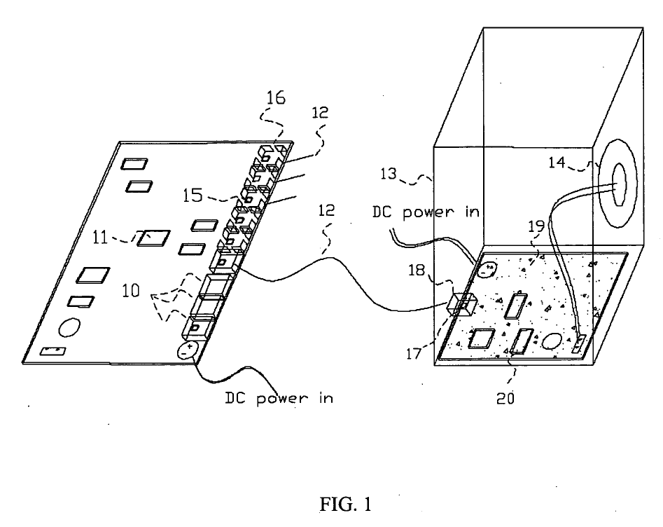

A typical embodiment of this invention is illustrated in FIG. 1. A typical embodiment of an optical digital audio system includes an audio signal receiving device 10, a digital audio amplifier and control device 11, one or multiple digital-to-optical converter(s) 15, one or multiple optical signal transmitter(s) 16, one or multiple optical fiber cable(s) 12, one or multiple optical signal receiver(s) 17, one or multiple optical-to-digital converter(s) 18, one or multiple digital signal amplifier(s) 19, one or multiple digital-to-analog converter(s) 20, and one or multiple speaker(s) 13 that has one or multiple analog-power speaker driver(s) 14.

The audio signal receiving device 10 accepts audio signal from various audio input sources. The input signal can be in digital, analog, or optical format but it will be converted to digital audio signal and fed to the digital audio amplifier and control device 11. The digital audio amplifier and control device 11 processes the audio signal, defines the frequencies and amplitude, and performs the crossover function, then delivers the audio signal to the digital-to-optical converter 15. The digital-to-optical converter 15 converts the signal to optical format, and the optical signal transmitter 16 transmits the optical audio signal through optical fiber cable 12 to the optical signal receiver 17 at the designated speaker unit 13. The optical-to-digital converter 18 then converts the signal back to digital format for the digital signal amplifier 19 to increase the amplitude of the audio signal. This amplified signal is then converted to analog format by the digital-to-analog converter 20 and combines with electrical power to activate the analog-power speaker driver(s) 14 to produce sound.

In this typical embodiment of the present invention, the audio signal receiving device 10, the digital audio amplifier and control device 11, the digital-to-optical converter(s) 15, and the optical signal transmitter(s) 16 constitutes an input receiver module, or simply referred to as input module; the optical signal receiver 17, the optical-to-digital converter 18, the digital signal amplifier 19, the digital-to-analog converter 20, and the speaker 13 that has one or multiple analog-power speaker driver(s) 14 constitutes an output speaker module, or simply referred to as output module. The output speaker module is connected to the input receiver module by optical fiber cable 12. Depending on the application, multiple output speaker modules can be connected to an audio signal receiver module for multi-channel sound.

The optical digital audio system transmits audio signal to speaker(s) by means of optical fiber cable(s). In an optical digital audio system, the power amplifier function is decentralized, whereby the audio signal is maintained in digital format to be transmitted optically from the input receiver module to the output speaker module(s). The digital signal is amplified and converted to analog format at the speaker level, then combines with electrical power to activate the speaker for sound reproduction.

In this invention, The optical fibers replace the conventional metal-type speaker wire as the higher efficiency audio signal transmission medium, freeing the audio system from interference, signal loss, and distortion, thus better retains the original quality of the audio signal.

Additional advantages of optical fiber over conventional speaker wire includes: Optical fiber is a non-emission medium and is free from electromagnetic interference; An optical fiber cable used in audio system typically measures about 2 to 4 mm in diameter, much smaller and easier to handle than metal-type speaker wire; Also, optical fiber cable is typically of lighter weight than metal-type speaker wire.

Furthermore, this invention provides end-to-end digitalization of audio system by extending the digital signal transmission channel all the way down to the very end at the speaker level. Whereby, the audio signal integrity is maintained in digital format throughout the system. By means of optical fiber, such extended digital transmission channel possesses a significantly higher bandwidth to accommodate the high audio resolution to be prescribed by the future generation digital audio, video and multimedia equipment.

Although the description above contains many specificities, these should not be construed as limiting the scope of the invention but as merely providing examples of the presently preferred embodiment of this invention. For example, the speaker unit 13, 14 can be housed in a separate casing and attached externally to, instead of integrated in, the output module.

Thus the scope of the invention should be determined by the appended claims and their legal equivalents, rather by the examples given.

1. An optical digital audio system comprising:
a. an input module that accepts audio signal from an input source and converts such signal to optical format,
b. an output module that can be joined with a speaker to accept the optical signal from said input module and converts said optical signal to format that is appropriate for sound reproduction at said speaker,
c. an optical fiber connection between said input module and said output module,
whereby audio signal from said input source will be transmitted optically to said speaker to retain signal integrity for sound reproduction at said speaker.

2. The optical digital audio system of claim 1, further including an amplifier in said output module for increasing amplitude of the audio signal for speaker output.

3. The optical digital audio system of claim 2, further including an amplifier and control device in said input module for processing the input signal so that said signal is ready to be amplified for speaker output, before being converted to optical format for transmission.

4. A method of transmitting audio signal to speaker comprising converting such signal to optical format for transmission over optical fiber, then converting the transmitted optical signal at said speaker to an appropriate format for sound reproduction, whereby original quality of such signal is retained for sound reproduction processing at said speaker.

5. The method of transmitting audio signal to speaker of claim 4, further including reverting the transmitted optical signal to digital format at said speaker, then amplifying and converting said signal to analog format to activate said speaker.
